(19) United States
(12) Patent Application Publication
(10) Pub. No.: US 2010/0033478 A1
(43) Pub. Date: Feb. 11, 2010

(54) Multimedia display device

(75) Inventor: NICHOLAS DAVID FOTHERGILL-ZITTRER, Toronto (CA)

Correspondence Address: Wang Law Firm, Inc., 4989 Peachtree Parkway,, Suite 200, Norcross, GA, 30092, US

(73) Assignee: Huveur Technologies Inc., Taichung City (TW)

(21) Appl. No.: 12/501,452

(22) Filed: Jul. 12, 2009

(30) Foreign Application Priority Data
Aug. 8, 2008 (TW) 097130387

(51) Int. Cl. G06T 1/00

(52) U.S. Cl. 345/418

(57) ABSTRACT

A multimedia display device includes a display device, a central processing unit, a flash memory unit, a database joint playing unit and a communication unit. The multimedia display device is provided for downloading and storing a portion of network multimedia data, and linking another portion of the network multimedia data of a network server to a multimedia data website, such that the display device produces a photo archive mode of the stored multimedia data and the multimedia data linked to the network server for the display device to play a photo archive.

### BACKGROUND OF THE INVENTION

1. Field of the Invention

The present invention generally relates to a multimedia display device, and more particularly to a multimedia display device provided for an archive view of photos stored in the display device and multimedia data linked to a network.

2. Description of the Related Art

Photography is a fantastic way of recording good memory, and photographs taken by means of traditional cameras and films can be developed and put into a photo frame or album for our appreciation, but the photo frame or album usually comes with a limited capacity and cannot store all of our desired photos.

As science and technology advance, a digital photo frame is introduced to the market. Unlike the conventional album, the digital photo frame is much thinner and capable of showing more digital photos and allowing users to change the photos from time to time, and thus the digital photo frame gradually takes over the traditional way of storing photos and becomes a mainstream product of the market.

Many people use a digital camera or any other image device to digitize images and facilitate the storage of photos, or use a digital photo frame to display digital images transmitted via files or downloaded from a network, wherein the files of images are processed and converted into digital images to facilitate their display through a display device. Users can select and set a playback mode by software, and make a diversified use of digital images in a simpler and more convenient manner.

The source of photos played in a digital photo frame may be stored in a memory device such as a memory card of a computer or a digital camera, and installed into the digital photo frame for their playback. However, the digital photo frames of this sort have a drawback on replacing a photo, since users have to go through the processes of removing the memory card, updating a photo file in the memory card, and inserting the memory card back into the digital photo frame. Although the conventional digital photo frame provides a convenient way of browsing the photos, yet such digital photo frame does not allow users to update photos directly and obviously requires improvements.

Furthermore, the digital photo frame can be connected to a network server such as a network album website to download multimedia image data via a network communication to the digital photo frame for the playback of the photos. However, such digital photo frame downloads and plays the multimedia data through the network communication, so that it is necessary to consider the bandwidth limitation of the network and the memory capacity of the digital photo frame, or else the transmission rate of multimedia data will affect the playback quality adversely.

Finding a way of overcoming the aforementioned shortcomings of the conventional digital photo frame, allowing the digital photo frame to be connected to a network to update and play multimedia data, and enhancing the playback quality of multimedia data linked to the network is a key point of the present invention.

### SUMMARY OF THE INVENTION

Therefore, it is a primary objective of the present invention to provide a multimedia display device to overcome the bandwidth limitation of the network for transmitting data by the display device, so as to enhance the playback quality of the network multimedia data by the digital photo frame.

To achieve the foregoing objective, the present invention provides a multimedia display device for downloading and accessing a multimedia data by the display device and communicating with a network server to link a network multimedia data to jointly play the multimedia data and the network multimedia data, and the multimedia display device comprises:

a display device, for performing a playback according to a photo archive mode;

a central processing unit;

a database joint playing unit, for accessing and downloading a playback communication data of the multimedia data and the database joint playing unit having a storage memory playing area provided for storing a predetermined quantity of multimedia data after the multimedia is downloaded from the network server and accessing the playback communication data of the downloaded multimedia data;

a flash memory unit, for temporarily storing the communication data after the network multimedia data is updated by the network server each time, and the flash memory unit having a network link playback area for playing the multimedia data stored in the network server and the multimedia data accessed by a network communication and stored in the storage memory playing area according to the photo archive mode;

a communication unit, for communicating with the network server, and also communicating with the flash memory unit and the database joint playing unit through the central processing unit, comparing the retrieved and buffered playback communication data with the non-played communication data, after the flash memory unit retrieves the updated network multimedia data and playback communication data, and updating the playback communication data stored in the storage memory playing area after the comparison takes place, and playing the multimedia data at the display device according to the adjusted photo archive mode after the database joint playing unit adjusts the photo archive mode according to the status of the updated and played playback communication data.

### BRIEF DESCRIPTION OF THE DRAWINGS

FIG. 1 is a schematic view of a system structure of the present invention;

FIG. 2 is a schematic view of a network link of a first preferred embodiment of the present invention;

FIG. 3 is a schematic view of updating a first retrieved communication data in accordance with a first preferred embodiment of the present invention;

FIG. 4 is a schematic view of updating a fifth retrieved communication data in accordance with a first preferred embodiment of the present invention;

FIG. 5 is a schematic view of updating a sixth retrieved communication data in accordance with a first preferred embodiment of the present invention;

FIG. 6 is a schematic view of a network link of a second preferred embodiment of the present invention;

FIG. 7 is a schematic view of updating a first retrieved communication data in accordance with a second preferred embodiment of the present invention;

FIG. 8 is a schematic view of updating a sixth retrieved communication data in accordance with a second preferred embodiment of the present invention; and

FIG. 9 is a schematic view of updating a tenth retrieved communication data in accordance with a second preferred embodiment of the present invention.

### DETAILED DESCRIPTION OF THE PREFERRED EMBODIMENTS

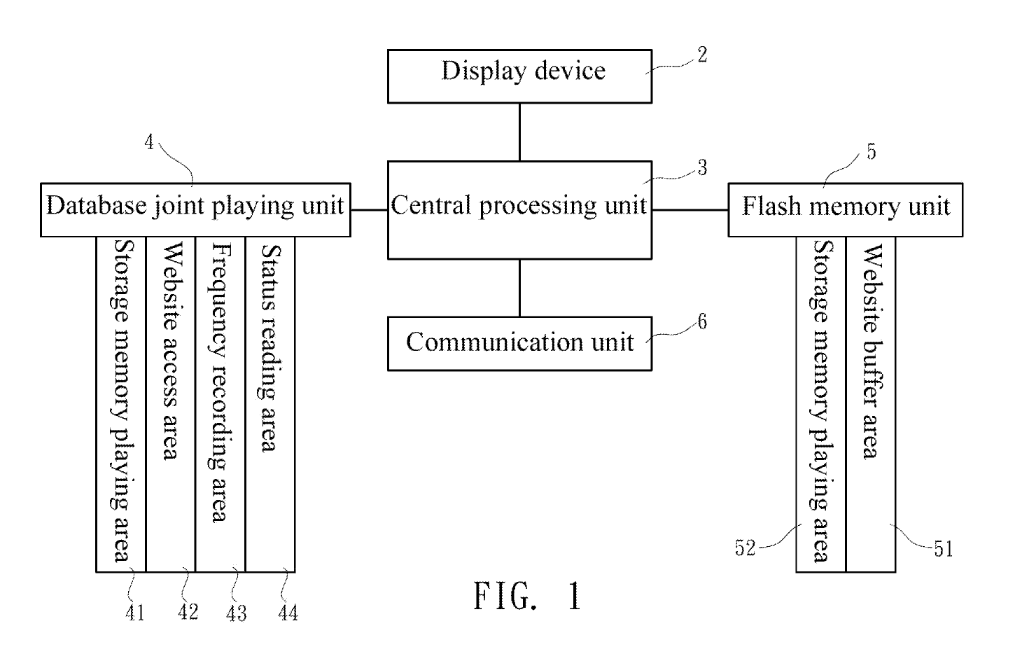

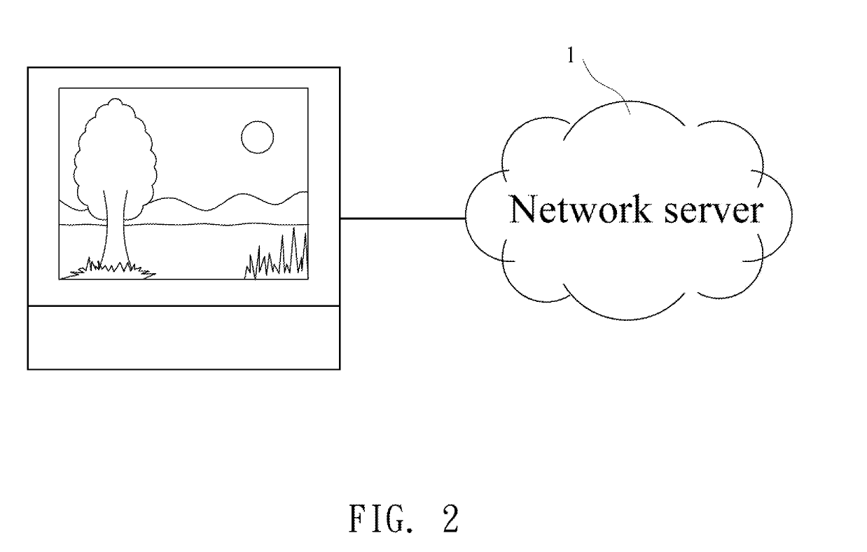

With reference to FIGS. 1 to 5 for a preferred embodiment of the present invention, the preferred embodiment is provided for illustrating the invention only, but not intended for limiting the scope of the invention.

This preferred embodiment of the invention provides a multimedia display device for downloading and accessing a multimedia data by a display device and communicating with a network server to link a network multimedia data and jointly play the multimedia data and the network multimedia data, and the multimedia display device comprises:

a display device 2, for performing a playback according to a photo archive mode;

a central processing unit 3;

a database joint playing unit 4, having a storage memory playing area 41 for storing a predetermined quantity of multimedia data downloaded from the network server 1 and accessing the playback communication data of the downloaded multimedia data;

a flash memory unit 5, for temporarily storing the communication data after the network multimedia data is updated by the network server 1 each time, and the flash memory unit 5 having a network link playback area for playing the multimedia data stored in the network server 1 and the multimedia data accessed by a network communication and stored in the storage memory playing area 52 according to the photo archive mode, and the flash memory unit 5 of this preferred embodiment has a website buffer area 51 for a multimedia data website of the buffering network server 1, wherein the buffered communication data is the multimedia data website, a network link playback area 52 for communicating with network server 1 and playing the multimedia data stored in the network server 1, and the multimedia data accessed by the network communication together with the storage memory playing area 41 according to the photo archive mode;

a communication unit 6, for communicating with the network server 4 and the flash memory unit 5 through the central processing unit 3, wherein the database joint playing unit 4 in this preferred embodiment includes a website access area 42 for accessing each multimedia data website of the network server 1, and the database joint playing unit 4 includes a frequency recording area 43 for accumulating the number of times of retrievals, and the database joint playing unit 4 includes a status reading area 44 for determining whether or not to play each multimedia data, and the played communication data includes the multimedia data website accessed in the database joint playing unit 4, the number of times of retrievals, and the playing status of the multimedia data, and each multimedia data in the database joint playing unit 4 is arranged in a descending order in the frequency recording area 43, and the communication unit 6 reads and determines the number of times of retrievals of each multimedia data in the frequency recording area 43 and rearranges the multimedia data for each time of retrieval.

After the network multimedia data is retrieved by the flash memory unit 5, the communication unit 6 compares the temporarily stored communication data after the retrieval with the playback communication data before the retrieval. After the comparison takes place, the playback communication data stored in the database joint playing unit 4 is updated, and the database joint playing unit 4 updates the status of the playback communication data and adjusts the photo archive mode, and then the display device 2 plays the multimedia data according to the adjusted photo archive mode.

In this preferred embodiment, the communication unit 6 compares each multimedia data website after the multimedia data being retrieved from the website buffer area 51 with each corresponding multimedia data website before the network multimedia being retrieved from the website access area 42. After the two are compared and a change of multimedia data occurs, a playback state is stored in the status reading area, and the number of times of retrieval is accumulated into the frequency recording area 43 to generate a playback communication data after the update, and both database joint playing unit 4 and flash memory unit 5 adjusts the photo archive mode according to the playback communication data, and then the display device 2 plays the multimedia data.

Each multimedia data website after being retrieved from the website buffer area 51 is compared with each corresponding multimedia data website before being retrieved from the website access area. If the multimedia data website of the former has a corresponding multimedia data website of the later, the status reading area 44 is determined as a playing status, and the number of times of retrieval in the frequency recording area 43 is accumulated. If the multimedia data website of the former corresponds to a newly added multimedia data website of the later, then the status reading area 44 is determined as a playing status, and the number of times of retrievals in the frequency recording area 43 is accumulated. If the multimedia data website of the former has no corresponding multimedia data website of the later, then the status reading area 44 is determined as a non-playing status, and the accumulation of the number of times in the frequency recording area 43 will stop.

In the photo archive mode of this preferred embodiment, the display device 2 plays a predetermined portion of multimedia data by downloading and storing the multimedia data into the storage memory playing area 41 first and then plays the data at the display device 2, and another portion of multimedia data is linked to the network link playback area 52 and communicated with the network server 1 to transmit and play the multimedia data stored in the network server 1 at the display device 2.

In this preferred embodiment, if the quantity of multimedia data downloaded and stored into the storage memory playing area 41 is less than the predetermined quantity, the space of multimedia data other than the predetermined quantity after the comparison made by the communication unit 6 is filled by the multimedia data downloaded to the multimedia data website after the network link playback area 52 is linked for the playback. If the number of multimedia data linked and played in the network link playback area 52 is sufficient to fill the number of multimedia data deleted from the storage memory playing area 41, the multimedia data is downloaded from the multimedia data website and filled sequentially. If the number of insufficient multimedia data is greater than the number of multimedia data linked and played in the network link playback area 52 after a predetermined number of multimedia data is downloaded and stored into the storage memory playing area 41, then the communication unit 6 compares the playback communication data with the communication data buffered in the flash memory unit 5, and the multimedia data meeting the requirement in the network link playback area 52 is downloaded from the multimedia data website and the multimedia data is linked and played in the network link playback area 52, wherein the multimedia data meeting the requirement of the multimedia data website is downloaded and filled according to a priority.

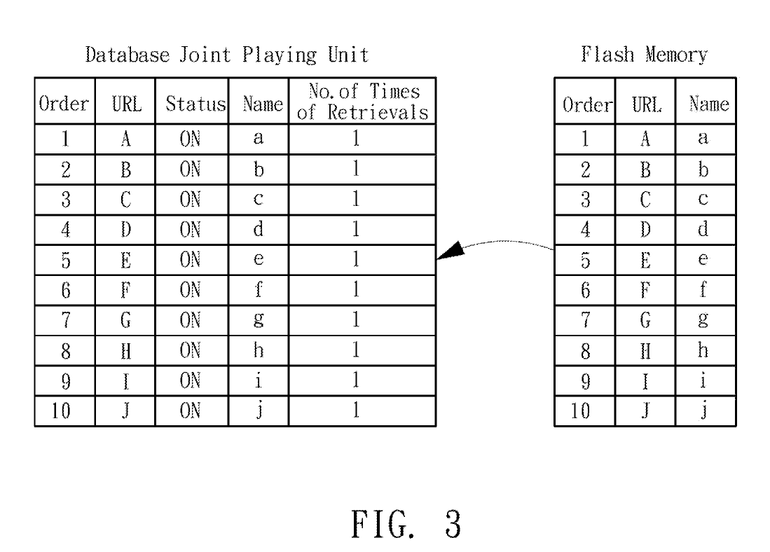

With reference to FIG. 3 for the use of a multimedia display device in accordance with the present invention, the network server has 10 records of network photos ready for a playback, and the default quantity of multimedia data in the storage memory playing area 41 is equal to 5. After the multimedia display device is connected with the network server 1, the communication data of the network multimedia data of the network server 1 is updated and temporarily stored in the flash memory unit 5, wherein the website of each of the 10 records of network multimedia data of the network server 1 is temporarily stored in the website buffer area 51. Now, the flash memory unit 5 has temporarily stored the website of the network multimedia data. In the first time of retrieving the playback communication data, the playback communication data does not contain any communication data, and thus the communication data temporarily stored in the flash memory unit 5 is compared by the communication unit 6 and updated to a corresponding communication data in the database joint playing unit 4. Now, the website access area 42 of the database joint playing unit 4 also has the website of the 10 records of network multimedia data of the network server 1, and the frequency recording area 43 starts accumulating the number of time of the retrieval(s) as 1, and the playback communication data in the status reading area 44 is set to a playing mode. The database joint playing unit 4 is communicated and linked with the network server 1 to download and storing 5 of the 10 records of network multimedia data to the storage memory playing area 41, and the multimedia data stored in the storage memory playing area 41 is sent to the display device 2 to start the playback. Starting from the time of playing the 5^{th} record, the communication unit 6 sets the status of the next record via a network transmission to a status of downloading and storing a playing multimedia data to the network link playback area 52 and getting ready for the playback, so that the 5 records of multimedia data in the storage memory playing area 41 and the 5 records of multimedia data in the network link playback area 52 can be played according to the aforementioned order.

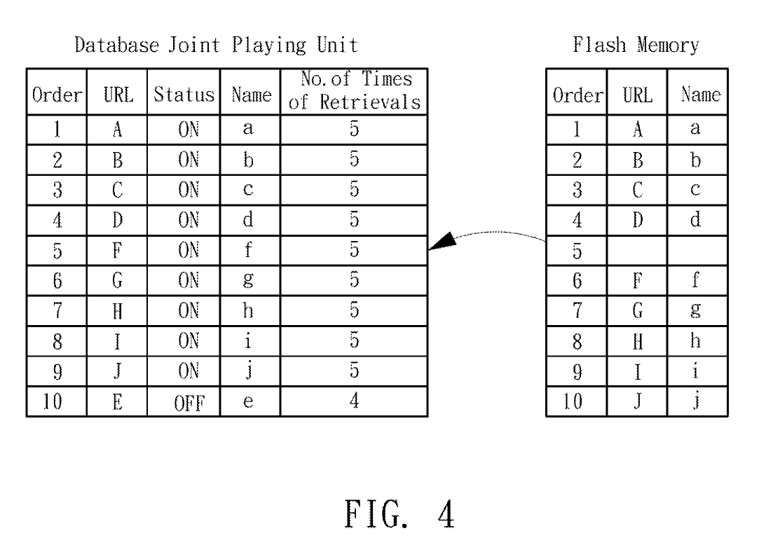

With reference to FIG. 4, if the network server 1 has deleted the 5^{th} record of the network multimedia data, and the flash memory unit 5 accessing and temporarily storing the communication data retrieved from the network server 1 does not contain the deleted record of network multimedia data and communication data, the and the flash memory unit 5 uses the communication unit 6 for the comparison, the communication data is updated to a playback communication data in the database joint playing unit 4, so that the status of the deleted record of multimedia data in the status reading area 44 is a non-playing status (OFF), and the number of times of retrievals of the frequency recording area 43 is still equal to 4, and the number of times of retrievals of other playing multimedia data is equal to 5. Since the number of times of retrievals of the deleted record of multimedia data is equal to 4, which is smaller than the number of times of retrievals (which is equal to 5) of other playing multimedia data, therefore the record of the deleted multimedia data is the playback communication data arranged at the end after the sorting. The playback communication data having an original 6^{th} sorted position is shifted to the 5^{th} position after the sorting, and it is necessary to compare the record of playback communication data with respect to the multimedia data of the URL and store the data into the storage memory playing area 41. The display device 2 sequentially plays 5 records of multimedia data stored in the storage memory playing area 41 and 4 records of multimedia data in the network link playback area 52.

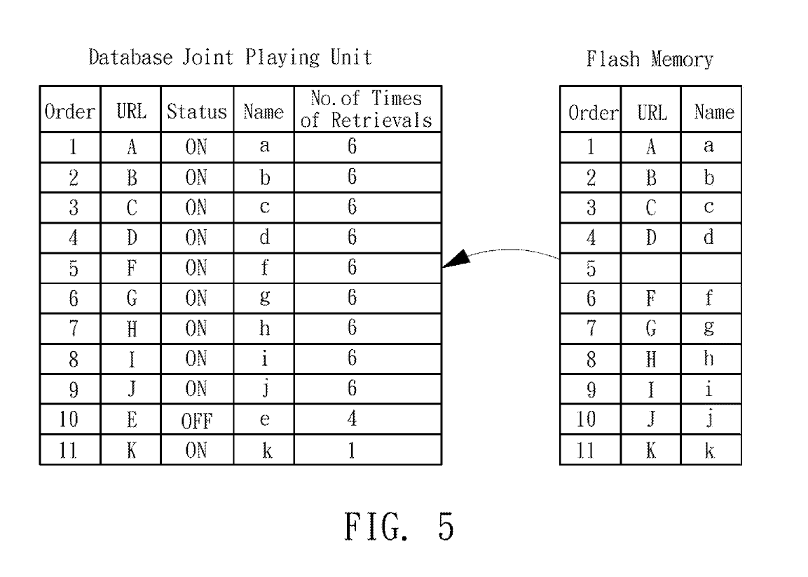

With reference to FIG. 5, a 11^{th} record network multimedia data is added into the network server 1 at the 6^{th} retrieval. Since the flash memory unit 5 retrieves a buffered communication data from the network server 1 to add the record of network multimedia data and communication data, the communication data is updated to the playback communication data in the database joint playing unit 4 after the flash memory unit 5 uses the communication unit 6 for the comparison, therefore the status of the record of the multimedia data in the status reading area 44 is a playing status (ON), and the number of times of retrievals accumulated in the frequency recording area 43 is equal to 1, and the number of times of retrievals of multimedia data in other playing mode is equal to 6. Therefore, the display device 2 will sequentially play 5 records of multimedia data stored in the storage memory playing area 41 and 5 records of multimedia data including the added multimedia data stored in the network link playback area 52.

Since the number of times of retrieving the foregoing deleted multimedia data stops at 4, therefore its sorted position is still higher than that of the newly added multimedia data (having the number of times of retrieval equal to 1). If the number of times of retrievals is greater than 4, the record of the deleted multimedia data has a smallest number of times of retrievals after the comparison made by the communication unit 6, and thus its sorted position is arranged at the end.

In summation of the description above, the present invention has the following advantages. The multimedia display device of the invention comprises a database joint playing unit 4 and a flash memory unit 5, wherein the database joint playing unit 4 includes a storage memory playing area 41, and the flash memory unit 5 includes a network link playback area 52, and both database joint playing unit 4 and flash memory unit 5 are provided for the central processing unit 3 to communicate and compare the multimedia data communication data through a communication unit 6, so that a portion of multimedia data is downloaded and stored in the storage memory playing area 41 for a playback, and another portion of multimedia data is linked by the network link playback area 52 and the network server 1 for transmitting and playing the photos. In the invention, the display device plays a predetermined number of multimedia data stored in the display device to reduce the bandwidth limitation of a network for linking the display device for transmission and communication, and the playback quality of the network multimedia data is improved over the traditional digital photo frame.

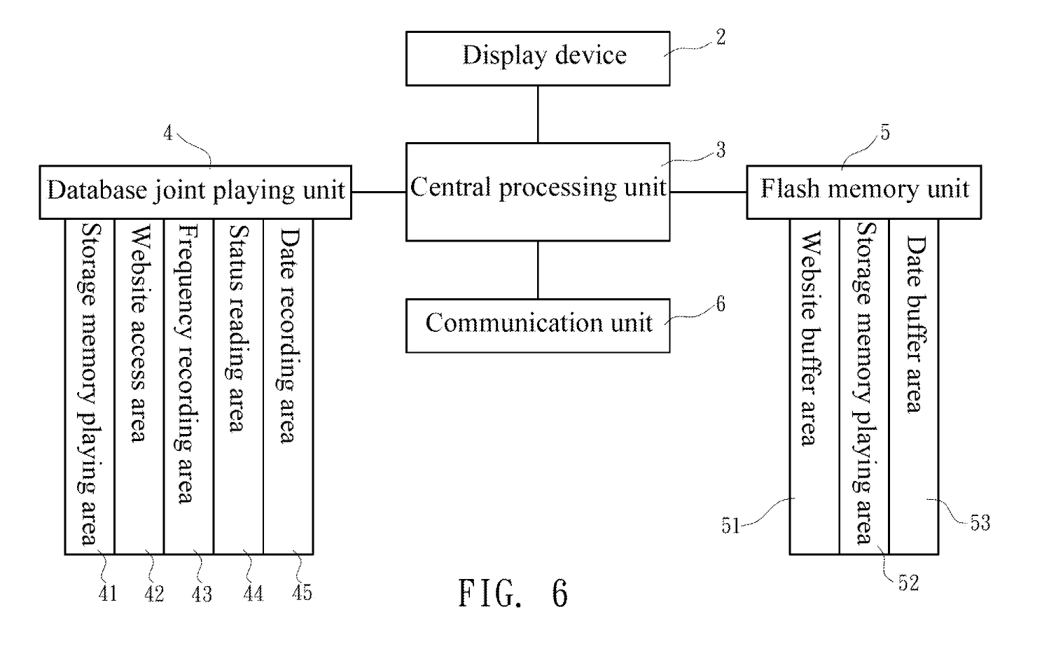

Of course, there are many other embodiments of the invention, but these embodiments have minor modifications only. With reference to FIGS. 6 to 9 for a second preferred embodiment of the present invention, the playback communication data of the database joint playing unit 4 further includes a date recording area 45 for recording a date of retrieving each multimedia data, and the communication unit 6 compares a multimedia data having an early retrieval date in the date recording area 45 and downloads such multimedia data as a substitute, and the flash memory unit 5 for temporarily storing the communication data and further includes a date buffer area 52 for temporarily storing a retrieval date of each multimedia data, and the communication unit 6 updates the retrieval date of the date buffer area 52 to a corresponding retrieval date of each multimedia data in the date recording area 45.

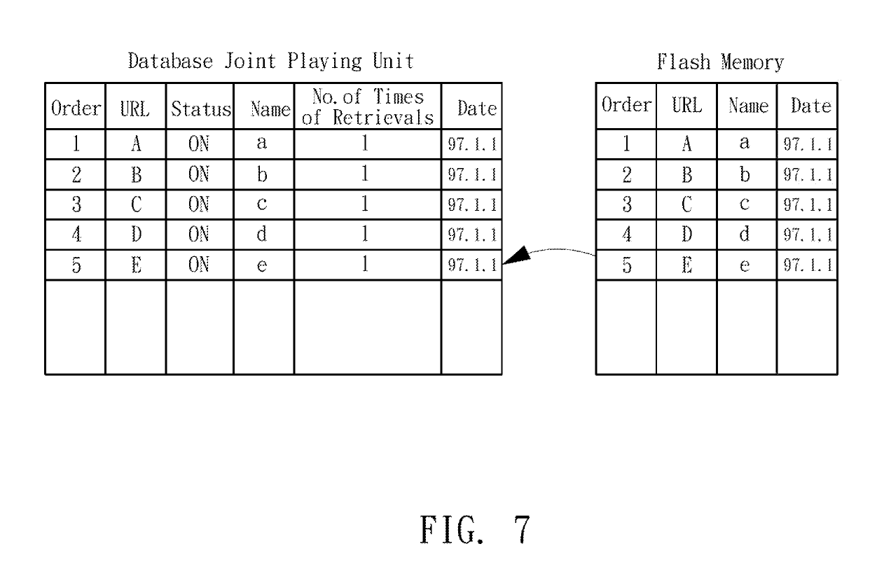

With reference to FIG. 7 for the 1^{st} time of retrieval, the network server 1 has 5 records of network multimedia data, and the flash memory unit 5 uses the communication unit 6 to updated the retrieved communication data to the playback communication data of the database joint playing unit 4, such that the status of the 5 records of multimedia data of the status reading area 44 is set to a playing mode, and the number of times of retrieval of each multimedia data is equal to one when the frequency recording area 43 starts accumulating the number of times. Therefore, the storage memory playing area 41 downloads the 5 records of multimedia data from the network server 1 and stores the data. When the display device 2 plays the 5 records of data, no network multimedia data is in the network link playback area 52.

In the 5^{th} retrieval, if the 4^{th} record of network multimedia data of the network server 1 is deleted on January 1 and the 5^{th} record of network multimedia data is deleted on January 2, the statuses of the two deleted records of multimedia data in the status reading area 44 are both in a non-playing mode, provided the final numbers of times of retrievals of the two deleted records of multimedia data in the frequency recording area 43 are both equal to 4, and the number of times of retrievals of the multimedia data at other playing modes is equal to 5.

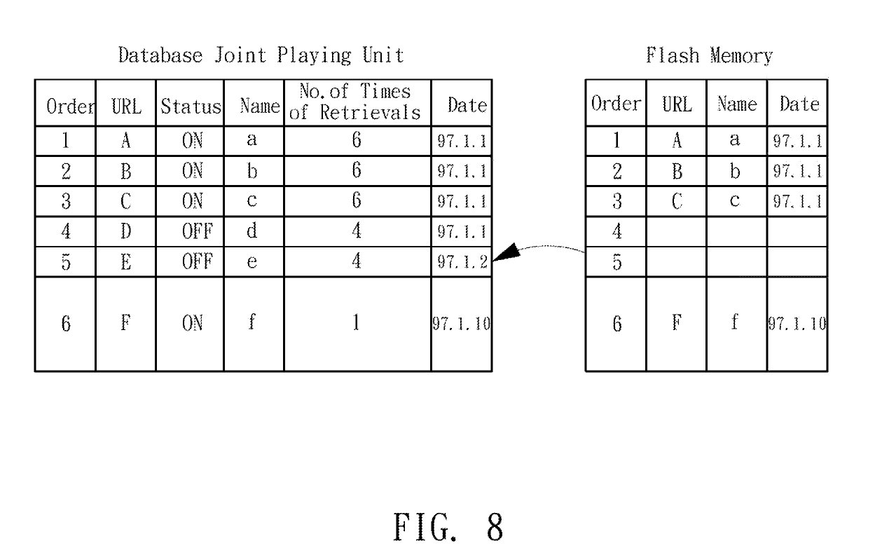

With reference to FIG. 8 for the 6^{th} retrieval, the network server 1 adds a new network multimedia data, and the number of time(s) of the retrieval of the newly added network multimedia data in frequency recording area 43 starts fat 1, and the number of times of retrievals of multimedia data at other playing modes is equal to 6, and the number of times of retrievals of the two deleted but not played multimedia data is still equal to 4.

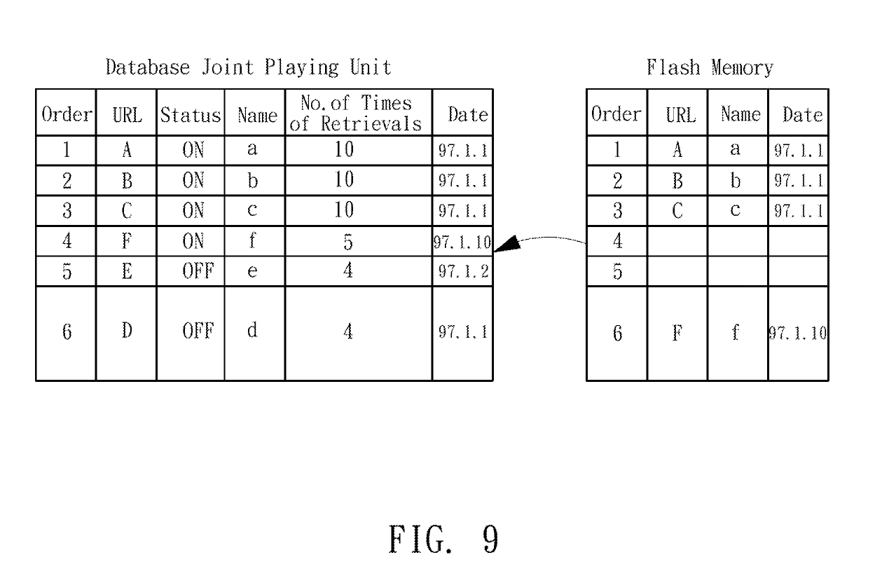

With reference to FIG. 9 for the 10^{th} retrieval, the number of times of retrievals of the newly added multimedia data is equal to 5, which is greater than the number of times of retrievals of the two deleted multimedia data, and thus the newly added multimedia data is a multimedia data with an early substitute date. In other words, the substitute of the newly added multimedia data substitutes the multimedia data deleted on January 1, and the deleted multimedia data is linked to and played by the network link playback area 52.

What is claimed is:

1. A multimedia display device, for downloading and accessing a multimedia data by the display device and communicating with a network server to link a network multimedia data to jointly play the multimedia data and the network multimedia data, and the multimedia display device comprising:
a display device, for performing a playback according to a photo archive mode;
a central processing unit;
a database joint playing unit, for accessing a playback communication data of the downloaded multimedia data and the database joint playing unit having a storage memory playing area provided for storing a predetermined quantity of multimedia data after being download from the network server and accessing the playback communication data of the downloaded multimedia data;
a flash memory unit, for temporarily storing the communication data after the network multimedia data is updated by the network server each time, and the flash memory unit having a network link playback area for playing the multimedia data stored in the network server play by a network communication and the multimedia data stored in the storage memory playing area according to the photo archive mode;
a communication unit, for communicating with the network server, and communicating with the flash memory unit and the database joint playing unit through the central processing unit, comparing the retrieved and buffered playback communication data with the playback communication data which is not retrieved yet, after the flash memory unit retrieves the playback communication data of the updated network multimedia data, and updating the playback communication data stored in the storage memory playing area after the comparison, and playing the multimedia data at the display device according to the adjusted photo archive mode after the database joint playing unit adjusts the photo archive mode according to the status of the updated and played playback communication data.

2. The multimedia display device of claim 1, wherein the display device play predetermined number of the multimedia data according to the photo archive mode, and a portion of multimedia data downloaded and stored in the storage memory playing area, and another portion of multimedia data is communicated and linked to the network link playback area of the network server through the communication unit, and the multimedia data stored in the network server is transmitted to and played by the display device.

3. The multimedia display device of claim 1, wherein the flash memory unit further comprises a website buffer area for temporarily storing a multimedia data website of a network server, and the buffered playback communication data is the multimedia data website, and the database joint playing unit includes a website access area for accessing each multimedia data website of the network server, a frequency recording area for accumulating the number of times of the retrievals, a status reading area for determining whether or not to play each multimedia data, and the played playback communication data includes the multimedia data website accessed in the database joint playing unit for accumulating a number of times of retrievals and a playing status of the multimedia data; the communication unit, and each accessed multimedia data website in the website buffer area after the retrieval is compared each corresponding multimedia data website before the retrieval, and a change of playing statuses of the multimedia data is determined after both multimedia data are compared, and the playing status is stored in the status reading area, and the number of times of retrievals is accumulated in the frequency recording area to produce an updated playback communication data, and the database joint playing unit adjusts the photo archive mode according to the playback communication data and then the display device plays the multimedia data.

4. The multimedia display device of claim 3, wherein each multimedia data website in the website buffer area after the retrieval is compared with each corresponding multimedia data website in the website access area before the retrieval, and if the multimedia data website of the former corresponds to the multimedia data website of the later, the status reading area will be determined as in a playing status, and the number of updates in the frequency recording area is accumulated, and if the multimedia data website of the former corresponds to a newly added multimedia data website of the later, then the status reading area will be determined as in a playing status, and the number of retrievals in the frequency recording area will be accumulated, and if the multimedia data website of the former does not correspond to the multimedia data website of the later, then the status reading area will be determined as in a non-playing status, and the number of retrievals in the frequency recording area will stop accumulating.

5. The multimedia display device of claim 3, wherein the multimedia data pre-played in the database joint playing unit are arranged in a descending order of the number of times of the retrieval in the frequency recording area, and the communication unit reads the number of times of retrievals each multimedia data in the frequency recording area and rearranges the multimedia data, for each time of retrieval.

6. The multimedia display device of claim 1, wherein the multimedia data linked and played in the network link playback area comes with an insufficient quantity for the substation after the deletion, the communication unit will compare the space excluding the predetermined number of multimedia data, and the multimedia data linked and played in the network link playback area will be downloaded from the multimedia data website for the substitution.

7. The multimedia display device of claim 6, wherein the multimedia data linked and played in the network link playback area comes with a sufficient quantity to substitute the deleted multimedia data in the storage memory playing area, and the multimedia data are downloaded from the multimedia data website according to the sorting priority and for a sequential substitution.

8. The multimedia display device of claim 6, wherein if the predetermined number of multimedia data downloaded and stored into the storage memory playing area has a quantity greater than the number of multimedia data linked and played in the network link playback area after the deletion, the communication unit will compare the playback communication data with the communication data buffered in the flash memory unit, and then the multimedia data meeting the condition of network link playback area is downloaded from the multimedia data website for the substitution.

9. The multimedia display device of claim 8, wherein the multimedia data linked to and played in the network link playback area are downloaded according to the sorting priority of the multimedia data website and substituted sequentially.

10. The multimedia display device of claim 8, wherein the playback communication data of the database joint playing unit further includes a date recording area for recording the retrieval date of each multimedia data, and the communication unit compares a data with an early retrieval date in the date recording area and meeting the requirement and downloads the data for substituting the multimedia data, and the buffered playback communication data of the flash memory unit further includes a date buffer area of temporarily storing the retrieval date of each multimedia data, and the communication unit updates the retrieval date in the date buffer area to a corresponding retrieval date of each multimedia data in the date recording area.
